(19) United States
(12) Patent Application Publication
(10) Pub. No.: US 2015/0343682 A1
(43) Pub. Date: Dec. 3, 2015

(54) VEHICLE INTERIOR PANEL AND METHOD OF MANUFACTURE

(71) Applicant: Johnson Controls Technology Company, Holland, MI (US)

(72) Inventors: Christopher Kring, Zeeland, MI (US); Michael G. Zimmer, Blemont, MI (US); Chih-her Suen, Holland, MI (US)

(21) Appl. No.: 14/728,972

(22) Filed: Jun. 2, 2015

Related U.S. Application Data
(60) Provisional application No. 62/006,372, filed on Jun. 2, 2014.
(60) Provisional application No. 62/044,497, filed on Sep. 2, 2014.

(51) Int. Cl. B29C 45/14; B29C 43/02; B60R 13/02

(52) U.S. Cl. CPC B29C 45/1418; B60R 13/02; B29C 43/02; B29C 45/14311; B29K 2023/12

(57) ABSTRACT

A method of manufacturing a vehicle interior panel includes providing a composite panel having a first thickness, inserting the composite panel into a mold, heating the composite panel, and compressing a first portion of the composite panel in a first region of the mold to a second thickness that is less than the first thickness.

### CROSS-REFERENCE TO RELATED APPLICATIONS

This application claims priority to U.S. Provisional Patent Application No. 62/006,372 filed Jun. 2, 2014 and U.S. Provisional Patent Application No. 62/044,497 filed Sep. 2, 2014, the entire contents of both of which are incorporated herein by reference.

### FIELD

The present invention relates to panels, and more particularly to interior panels for use in a vehicle.

### BACKGROUND

Some vehicle panels are compression formed from composite panels having a core material and a surface material. The surface material typically includes a plastic as the primary material. Prior to or during the compression forming process, heat is applied to the composite panel and the plastic surface partially melts and creates a poor surface appearance, which is undesirable in certain applications.

### SUMMARY

A method of manufacturing a vehicle panel includes providing a composite panel having a first thickness, inserting the composite panel into a mold, heating the composite panel, and compressing a first portion of the composite panel in a first region of the mold to a second thickness that is less than the first thickness.

Other features and aspects of the invention will become apparent by consideration of the following detailed description and accompanying drawings.

### DESCRIPTION OF THE DRAWINGS

FIG. 1 is a perspective exploded view of a mold for use in manufacturing a vehicle interior panel in accordance with an embodiment of the invention.

FIG. 2 is an exploded view of a composite panel used to create the interior panel of the invention.

FIGS. 3A-3B are cross-sectional view of a portion of the composite panel when compressed to create the interior panel of the invention, illustrating a transition from a compressed portion of the composite panel to a full-thickness, non-compressed portion of the composite panel.

FIG. 4 is a schematic side view of the interior panel of FIGS. 3A-3B, illustrating a transition distance between a compressed portion of the composite panel and a full-thickness, non-compressed portion of the composite panel.

FIG. 5 is a flowchart describing a method of manufacturing the interior panel of FIGS. 3A, 3B, and 4.

FIG. 6 is a flowchart describing a method of manufacturing the interior panel of the present invention according to another embodiment.

Before embodiments of the present invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

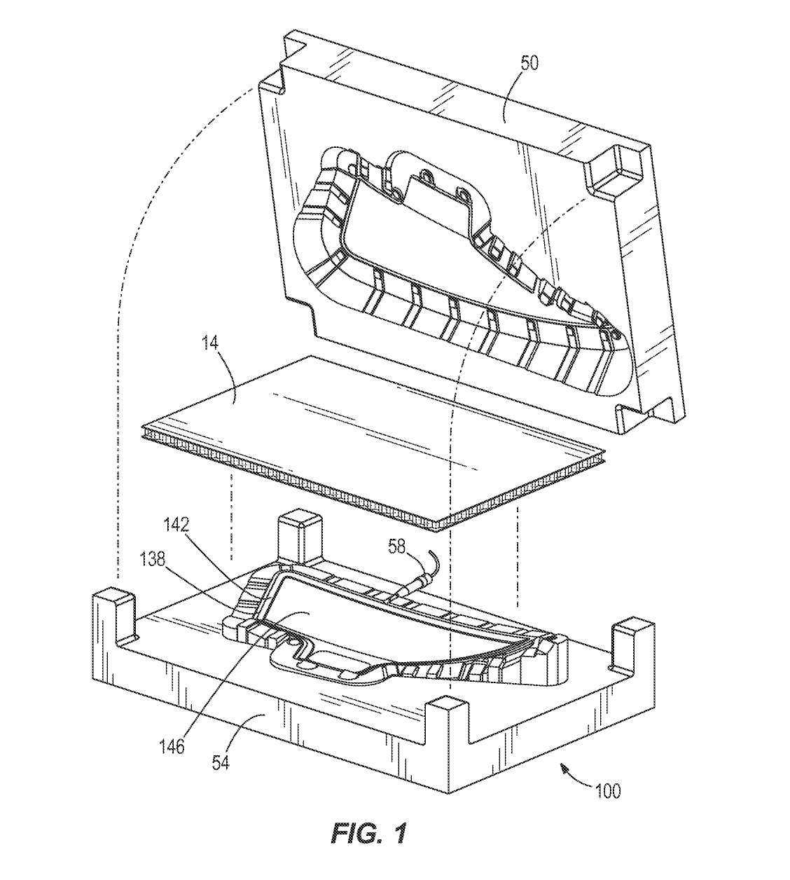

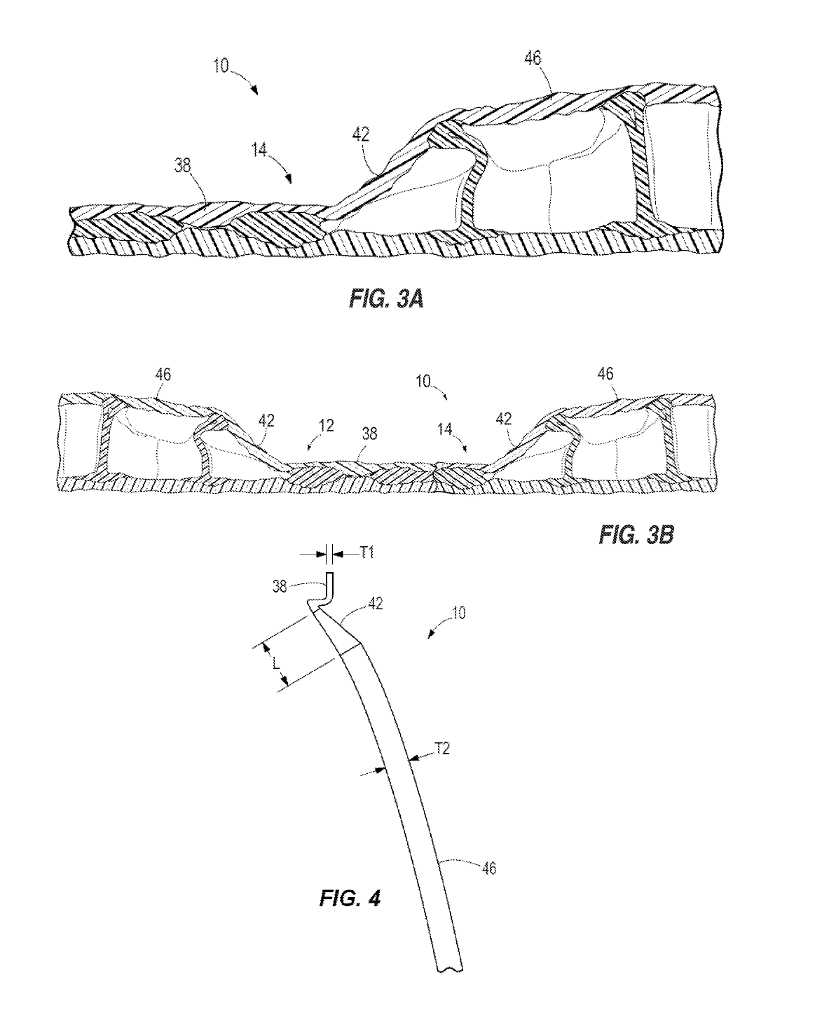

FIG. 1 illustrates a mold 100 for use in manufacturing a vehicle panel 10 (FIGS. 3A-3B) in accordance with an embodiment of the invention. The panel 10 is formed from a flat composite panel 14 (FIG. 1) and is shaped in accordance with a component frame of the vehicle with which the panel 10 is associated. For example, the panel 10 may be shaped for use within the interior of a vehicle a door frame of a vehicle, a roof frame of the vehicle (e.g., as a component of a headliner), a component of the flooring, an electronic or HVAC console, pillars (e.g., A pillar, B pillar, C pillar, D pillar), window frames, or any other component frame of the vehicle.

Various panels of a vehicle can benefit from the panel 14 of the present invention. For example, vehicles concerned with improved handling can benefit with a lower center of gravity. Additionally, large vehicles with tipping or rollover concerns can also benefit from a lower center of gravity. As the panel 14 is lighter than a metal (e.g. steel, aluminum) equivalent (e.g., similar specific strength), implementing the panel 14 into a roof frame or any panel above the center of gravity of the vehicle would result in a lower center of gravity. Such a vehicle would then also benefit from improved handling and a decreased propensity to rollovers.

By implementing the panels 14, which have a greater specific strength than most consumer grade metals, the size of the panels 14 can be less than that of a metal panel. Therefore, vehicular components such as doors, pillars, and other panels can be made thinner, providing increased space within the cabin of the vehicle. As described in greater detail below, panels 14 of the present invention can be formed to have tighter tolerances than conventional panels formed according to traditional techniques.

Further, fuel efficiency is increased as the vehicle weight is decreased. Therefore, with growing regulations and buyer demand for increased efficiency, auto manufacturers can benefit financially from implementing the panels 14 into many different interior and exterior vehicle components.

While reference is made herein to “interior” panels 10 and to other specific panel locations on a vehicle, in some embodiments, the panels 10 of the present invention can also provide exterior structure of a vehicle. In some such embodiments, a first portion of the panel 10 can define an interior of the vehicle, while a second portion of the panel 10 can define an exterior surface of the vehicle. In some such embodiments, the panels 10 of the present invention can define portions of doorframes, trunk openings, moon roofs, vehicle underbody, truck beds, etc. In such embodiments, the panels 10 can include non-linear shapes to follow the contours of the vehicle exterior. The panels can therefore provide increased aerodynamics for the vehicle, adjust the level of downforce felt by the vehicle, and provide an aesthetic accent to one or both of the exterior and the interior of the vehicle.

With reference to FIG. 4, the present invention provides a method for forming a panel 14 from multiple layers of generally linear material. The resulting panel 14 can have different cross-sectional shapes, multiple surface convolutions and multiple areas of differing cross-sectional thicknesses along the length of the panel. In other embodiments, the process of the present invention can be used to form panels having a more linear configuration with only a single surface convolution or single change in material thickness.

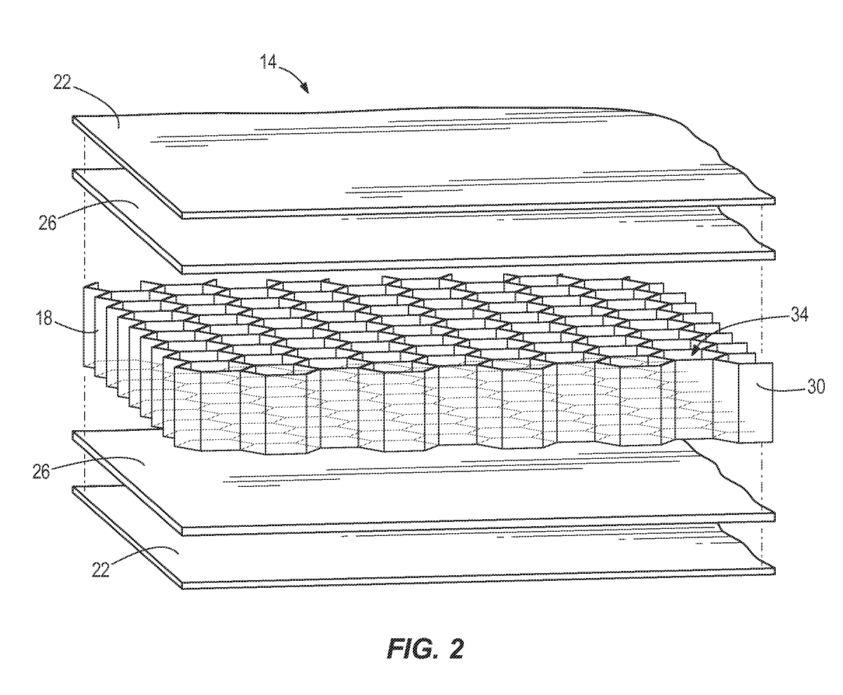

With reference to FIG. 2, the composite panel 14 includes a honeycomb-pattern core 18 and a pair of natural fiber skins 22 covering opposite sides of the core 18. Although the skins 22 are shown adhered to the core 18 by separate adhesive layers 26, the adhesive matrix material binding the natural fibers of each of the skins 22 may also be used for binding the skins 22 to the core 18. An olefin-based adhesive may be used for the layers 26, which may either take the form of adhesive sheets or a semi-liquid adhesive material. Alternatively, the adhesive may be an epoxy adhesive, urethane adhesive, methacrylate adhesive, cyanoacrylate adhesive, or an alternative wood, paper, and fiber adhesive. The core 18 includes a plurality of walls 30 that define a plurality of voids 34, and is made from a plastic material (e.g., polypropylene) or any other suitable composite or natural material. Furthermore, the core 18 may be manufactured using an injection molding process or any other conventional molding processes, through an extrusion process, via expansion, or through corrugation.

In the illustrated embodiment of FIGS. 2 and 3, the core 18 is made up of a plurality of hexagonal (honeycomb-pattern) wall structures. The walls 30 of the hexagons extend from one of the skins 22 or adhesive layers 26 to the other skin 22 or adhesive layer 26. Likewise, the void spaces 34 extend from one of the skins 22 or adhesive layers 26 to the other skin 22 or adhesive layer 26. The walls run generally perpendicular to the skins 22 and adhesive layers 26 thereby defining an uncompressed thickness between the skins 22 or adhesive layers 26. The core 18 may alternatively be made of walls 30 providing voids with different cross-sectional shapes (e.g., circular, triangular, polygonal, etc.) or even non-repeating shapes, so long as the walls 30 provide increased structural integrity to the composite panel 14. Different wall segments may have different thicknesses or dimensions. For example, the area of the core 18 to be compressed in the molding process may have thinner wall sections than that of the sections to remain uncompressed so that the molding process requires less force. Alternatively, the area of the core 18 to be compressed in the molding process may have thicker wall sections than that of the sections to remain uncompressed so that the strength of the entire panel remains more consistent across the length of the panel after molding.

The skins 22 include fibers held together by an adhesive matrix material. As mentioned above, the adhesive matrix material bonding the fibers may also be used to bond the skins 22 to the core 18. In some embodiments of the invention, the fibers include a combination of synthetic (e.g., polypropylene or other high-molecular weight thermoplastic polymers, including for example, acrylic, Nylon, polyether sulfone, polyethermide, and polycarbonate) fibers and long natural fibers such as bast fibers, or mineral fibers. For example, bast fibers may include flax, hemp, kenaf, jute, kudzu, nettle, okra, paper mulberry, ramie, roselle, or various other species of natural plant fibers. Mineral fibers may include glasswool, rockwool, slagwool, glass filaments, fiberglass, and ceramic fibers, among others. When used along an exterior of the vehicle, the bast fibers or mineral fibers may be coated with a film to prevent the absorption of water. In some embodiments, the fibers used to create the skins 22 include approximately 50% by weight polypropylene fibers and approximately 50% by weight bast fibers. Alternatively, the fibers used to create the skins 22 may include a different percentage (by weight) synthetic fibers (e.g., zero percent, 25 percent, 75 percent, 100 percent) and the corresponding percentage (by weight) bast fibers (e.g., 100 percent, 75 percent, 25 percent, zero percent). The percentages can vary based on the ratio of volume to surface area of the fibers. When using finer fibers, it may be beneficial to include additional adhesive. The adhesive matrix material bonding the fibers of the skins 22 may include, in some embodiments, an olefin-based adhesive or any other suitable type of adhesive. Different applications may utilize different percentages of synthetic and bast fibers. For example, a primarily structural (e.g., flooring or pillar) panel may utilize a greater percentage of synthetic fibers or other fibers having longer strands, and a more aesthetic panel may benefit from a greater percentage of bast fibers or other fibers having shorter strands.

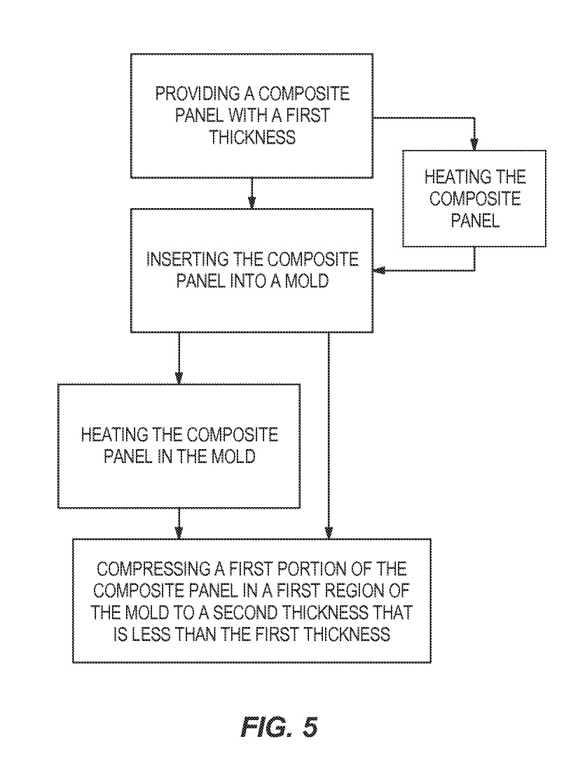

As described in detail below, the panel 14 is used in a compression molding process to create the interior panel 10. Specifically, as described in FIG. 5, the composite panel 14, which is provided with an initial or first thickness, which may be a substantially constant thickness across the length and width of the panel 14, is inserted into the mold 100, heated in the mold 100, and compressed to create the interior panel 10. In an alternative embodiment of the molding process, the composite panel 14 may be heated prior to insertion into the mold 100 with a heating process such as infrared, hot air heating, or contact heating. During compression molding of the composite panel 14, some portions of the composite panel 14, depending upon the final configuration and design of the interior panel 10, are completely collapsed or crushed to form regions of the interior panel 10 in which relatively high levels of design detail are desired. Such a compressed, collapsed, or crushed portion 38 of the composite panel 14 is shown in FIGS. 3A, 3B, and 4.

Alternatively, some portions of the composite panel 14 may be completely or partially collapsed or crushed to follow contours of various components of the vehicle such as user controlled mechanisms, audio-visual equipment, inlays, or internal mechanisms and spaces, among others. These contours may serve structural or space saving purposes, or may provide increased aesthetics within the vehicle. For example, as shown in FIG. 3B, a collapsed portion 38 may be surrounded by two uncompressed portions 46 to provide a custom fitted space for a vehicle component.

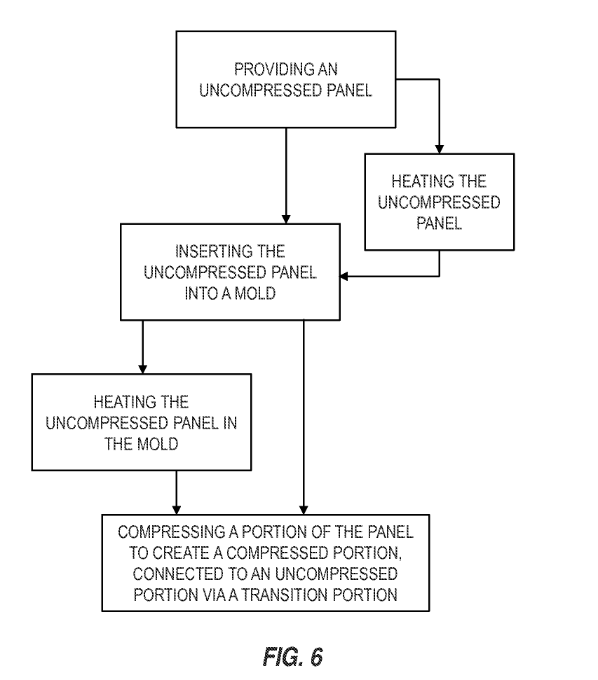

As shown in FIG. 6, the uncompressed composite panel 14 is inserted into the mold 100, heated in the mold 100, and compressed to create the interior panel 10. In an alternative embodiment of the molding process, the uncompressed panel 14 may be heated prior to insertion into the mold 100. During compression molding of the composite panel 14, some portions of the composite panel 14, depending upon the final configuration and design of the interior panel 10, are completely collapsed or crushed to form compressed portions 38. Such a compressed, collapsed, or crushed portion 38 of the composite panel 14 is shown in FIGS. 3A, 3B and 4, and is connected to the uncompressed portion 46 via a transition region 42.

During the compression molding process, to create one or more compressed or collapsed portion(s) 38, the composite panel 14 is compressed with a force sufficient to cause the individual walls 30 of the core 18 to buckle, thereby eliminating or substantially reducing the void spaces 34. The resulting thickness T1 (FIG. 4) of the collapsed portion 38 of the panel 10, therefore, is approximately equal to the combined thicknesses of the skins 22 and the crushed thickness of the core 18.

With reference to the embodiment of FIGS. 3A, 3B, and 4, the entirety of the composite panel 14 is not compressed during the compression molding process. Rather, when the collapsed portion 38 of the panel 10 is formed, a transition portion 42 is also formed adjacent the collapsed portion 38 for transitioning the collapsed portion 38, which has a thickness T1 less than that of the original composite panel 14 prior to compression molding, to a non-collapsed or non-compressed portion 46 having a thickness T2 substantially equal to that of the original composite panel 14 prior to compression molding. The collapsed portion 38, the transition portion 42, and the non-collapsed portion 46 of the interior panel 10 each are formed by corresponding regions in the mold 100 during the compression molding process, such as a collapsing region 138, a transition region 142, and a non-collapsing region 146, respectively (FIG. 1). When the two halves of the mold 50, 54 are fully compressed relative to one another around the composite panel 14, the non-collapsing region 146 is provided with a gap approximately equal to the original thickness T2 of the composite panel 14. The collapsing region 138 is provided with a gap approximately equal to the thickness T1 of the collapsed portion 38. In the illustrated mold 100, the collapsing region 138 coincides with an outermost periphery of the panel 10 created in the mold 100, while the non-collapsing region 146 coincides with the middle or interior portion of the panel 10 created in the mold 100. The transition region 142, consequently, spans a contiguous region of the panel 10 proximate the outermost periphery, between the collapsing region 138 and the non-collapsing region 146. While reference is made herein to mold “halves” 50, 54, in some embodiments, the interior panels 10 of the present invention can be formed by molds including any number of components (e.g., three-part molds), including interior mold components capable of producing a hollow.

In some embodiments, one or more collapsing regions 138 are formed by a second compression molding process which may or may not have the same compression forces and may be applied to areas already compressed or to neighboring areas which have not yet been compressed. In this manner, ribs or other structure can be interwoven within a structure to provide areas of increased density interspersed therewithin.

In one embodiment of the interior panel 10 illustrated in FIG. 4, the full thickness T2 of the original composite panel 14, and therefore the non-collapsed portion 46 of the panel 14, is approximately 5.2 mm and the reduced thickness T1 of the collapsed portion 38 is approximately 1.2 mm. The transition portion 42 connects the collapsed portion 38 and the non-collapsed portion 46, and includes a linearly increasing thickness as the transition occurs from the collapsed portion 38 to the non-collapsed portion 46. In this example, the transition portion 42 has a length L of approximately 10 mm and increases in thickness from one end to another at a rate of about 0.1 mm per one mm of length L of the transition portion 42 to about 0.5 mm per one mm of length L of the transition portion 42. In the illustrated embodiment of the interior panel 10, the thickness of the transition portion 42 increases at a rate of approximately 0.3 mm per one mm of length L of the transition portion 42. Stated another way, the length L of the transition portion 42 is approximately twice the thickness T2 of the non-collapsed portion 46 or the original thickness of the composite panel 14 prior to compression molding. Alternatively, the non-collapsed portion 46 of the composite panel 14 may be at least partially compressed during the compression molding process such that the thickness T2 of the non-collapsed portion 46 may be less than the original thickness of the composite panel 14 prior to compression molding. As a further alternative, different configurations of the interior panel 10 may require different values for the thicknesses T1, T2 of the composite panel 14 and length L of the transition portion 42.

Alternatively, the mold 100 may include fillets or chamfers between the collapsed portion 38 and the non-collapsed portion to more directly control the angle and length of the transition portion 42. A fillet or chamfer may additionally change the general shape of the transition portion 42. The transition portion 42 shown in FIGS. 3A-3B is generally linear, but the inclusion of a chamfer could produce a parabolic transition portion.

Further still, the interior panel 10 may include cascading, alternating, or random levels of collapsed portions 46 connected by transition portions 42. For example, an interior panel 10, having a single thickness prior to molding, may be molded according to the present invention to include multiple thicknesses in different areas of the panel 10 representative of different depths of compression. A transition portion 42 may then be formed between each change in thickness.

A region of the interior panel 10 which may include one or more of the collapsed portion(s) 38 described above could contain a radius, sharp edge or corner, or another detailed feature requiring a more dense substrate. Additionally, or in the alternative, the collapsed portion(s) 38 of the composite panel 14 may also be crushed in preparation for a secondary injection molding process to add additional detail to the interior panel 10. In such a process, an injection nozzle 58 is located in the collapsing region 138 of the mold 100 (FIG. 1) for spraying or otherwise depositing a melt material (e.g., plastic) onto the collapsed portion 38 of the interior panel 10 after it is compression molded. Additional nozzles 58 may be provided within the collapsing region 138 depending upon the overall size of the panel 10, the locations of the compressed regions 138 and the flow characteristics of the melt material. Additional mold components such as gates and runners may be included depending on the size and shape of the panel 10.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

Various features of the invention are set forth in the following claims.

What is claimed is:

1. A method of manufacturing a vehicle interior panel, the method comprising:
providing a composite panel having a first thickness;
inserting the composite panel into a mold;
heating the composite panel; and
compressing a first portion of the composite panel in a first region of the mold to a second thickness that is less than the first thickness.

2. The method of claim 1, wherein the composite panel includes an interior honeycomb core and a pair of natural fiber skins covering opposite sides of the interior honeycomb core.

3. The method of claim 2, wherein the composite panel includes a pair of adhesive layers that adhere, respectively, the natural fiber skins to the interior honeycomb core.

4. The method of claim 3, wherein the adhesive layers include an olefin-based adhesive.

5. The method of claim 2, wherein the natural fiber skins include bast fibers.

6. The method of claim 5, wherein the bast fibers are selected from a group consisting of flax, hemp, kenaf, and jute.

7. The method of claim 2, wherein the interior honeycomb core includes a polypropylene material.

8. The method of claim 2, wherein compressing the first portion of the composite material includes at least partially collapsing the interior honeycomb core.

9. The method of claim 8, further comprising locating an injection nozzle in the first region of the mold where the composite panel is at least partially collapsed.

10. The method of claim 9, further comprising injecting a melt material into the first region of the mold through the injection nozzle and onto the first portion of the composite panel.

11. The method of claim 1, further comprising providing a second region in the mold adjacent the first region in which a compressed thickness of the composite panel transitions from the second thickness toward the first thickness.

12. The method of claim 11, wherein the second region of the mold has a length that is approximately twice the first thickness of the composite panel.

13. The method of claim 11, wherein the second region of the mold has a length, and wherein a thickness of the second region of the mold increases at a rate of about 0.1 mm per one mm of length of the second region to about 0.5 mm per one mm of length of the second region.

14. The method of claim 13, wherein the thickness of the second region of the mold increases at a rate of about 0.3 mm per one mm of length of the second region.

15. The method of claim 11, further comprising providing a third region of the mold adjacent the second region corresponding to the first thickness.

16. The method of claim 15, wherein the first region coincides with an outermost periphery of the panel.

17. The method of claim 16, wherein the third region coincides with a middle portion of the panel.

18. The method of claim 11, further comprising providing a third region of the mold adjacent the second region with a thickness less than the first thickness and greater than the second thickness.

19. The method of claim 19, wherein the first region coincides with an outermost periphery of the panel and the third region coincides with a middle portion of the panel.

20. The method of claim 1, wherein heating the composite panel occurs before the composite panel is inserted into the mold.
